(19) United States
(12) Patent Application Publication
(10) Pub. No.: US 2014/0355653 A1
(43) Pub. Date: Dec. 4, 2014

(54) EXHAUST GAS TEMPERATURE SENSOR

(71) Applicant: Stoneridge, Inc., Warren, OH (US)

(72) Inventors: Michael L. Heston, Mansfield, OH (US); Jacob Biederman, Galion, OH (US); Brian Engelbach, Mansfield, OH (US)

(73) Assignee: Stoneridge, Inc., Warren, OH (US)

(21) Appl. No.: 14/271,417

(22) Filed: May 6, 2014

Related U.S. Application Data
(60) Provisional application No. 61/820,205, filed on May 7, 2013.
(60) Provisional application No. 61/915,313, filed on Dec. 12, 2013.

(51) Int. Cl. G01K 13/02; G01K 1/12

(52) U.S. Cl. CPC G01K 13/02; G01K 1/12; G01K 2205/04; G01K 2013/024
USPC 374/208

(57) ABSTRACT

A temperature sensor assembly including a tip body, a wire harness body, and a temperature sensing element. The tip body includes a closed end and an open end having a first flange portion. The wire harness body includes an open end having a second flange portion. A crimp couples the flange portions together to form a temperature sensor housing defining an interior cavity. The temperature sensing element is disposed within the interior cavity. A temperature sensor assembly may also include temperature sensing element and a temperature sensor housing defining an interior cavity. A distal end region of the interior cavity includes a temperature sensing element cavity defined by a closed end of the temperature sensor housing and configured to receive the temperature sensing element. A portion of the temperature sensing element cavity is heat-shrunk around a portion of the temperature sensing element.

### CROSS-REFERENCE TO RELATED APPLICATIONS

This application claims the benefit of U.S. Provisional Application No. 61/820,205, filed May 7, 2013, and U.S. Provisional Application No. 61/915,313, filed Dec. 12, 2013, both of which are fully incorporated herein by reference.

### TECHNICAL FIELD

The present disclosure relates generally to temperature sensors, and, more particularly, to an exhaust gas temperature sensor.

### BACKGROUND

Internal combustion engines such as, but not limited to, diesel and gasoline engines, may include one or more temperature sensors at least partially disposed within the exhaust gas system. These temperature sensors may sense the temperature of the exhaust gas and may be used, at least in part, by an engine control system to adjust one or more properties of the engine such as, but not limited to, air/fuel ratio, boost pressure, timing or the like. Because of the operating environment, the temperature sensors may be exposed to relatively harsh conditions including, but not limited to, vibration, exposure to debris, moisture and corrosive chemicals, large temperature ranges and relatively high continuous use operating temperatures. The conditions may degrade the performance of the temperature sensors and may, ultimately, render the temperature sensors unsuitable for their intended purpose.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a schematic illustration of a vehicle including a temperature sensor consistent with the present disclosure;

FIG. 2 is a perspective view of a housing for use with a temperature sensor consistent with the present disclosure;

FIG. 3 is a side view of the housing of FIG. 2;

FIG. 4 is an enlarged side cross-sectional view of a portion of the housing of FIG. 2;

FIG. 5 is an exploded view of a temperature sensor including a temperature sensor assembly and the housing of FIG. 2;

FIG. 6 is a perspective view of the temperature sensor of FIG. 5 in an assembled condition;

FIGS. 7A-7C are front, side and top cross-sectional views of a portion of the sensor tip and sensor element positioned within of the temperature sensor of FIG. 6;

FIG. 8 is a cross-sectional view of another embodiment of a temperature sensor assembly consistent with the present disclosure;

FIG. 9 is an exploded view of one embodiment of the tip body and the wire harness body of FIG. 8;

FIG. 10 is an exploded, cross-sectional view of one embodiment of the tip body and the wire harness body of FIG. 8;

FIG. 11 is a cross-sectional view of one embodiment of the insulator member of FIG. 8; and

FIG. 12 is a cross-sectional view of the insulator member of FIG. 11 taken along lines XII-XII.

### DETAILED DESCRIPTION

The present disclosure is generally directed at temperature sensors. Embodiments described herein may relate to an exhaust gas temperature sensor assembly, for example, an exhaust gas temperature sensor assembly configured to be used with an internal combustion engine such as, but not limited to, a diesel engine, a gasoline engine, or the like. The output of the exhaust gas temperature sensor assembly may be received by a controller to control one or more parameters of the engine, for example, but not limited to, air/fuel ratio, boost pressure, timing or the like. It should be appreciated, however, that a sensor and/or system consistent with the present disclosure may be used to detect, sense and/or monitor the temperature of other parameters, including, but not limited to, catalytic converter temperature, lubricant temperature (such as, but not limited to, engine oil, transmission oil, differential oil, or the like), brake temperature, engine coolant temperature, or the like. A sensor and/or system consistent with the present disclosure may be employed in connection with various other applications, both related to, and unrelated to, vehicles.

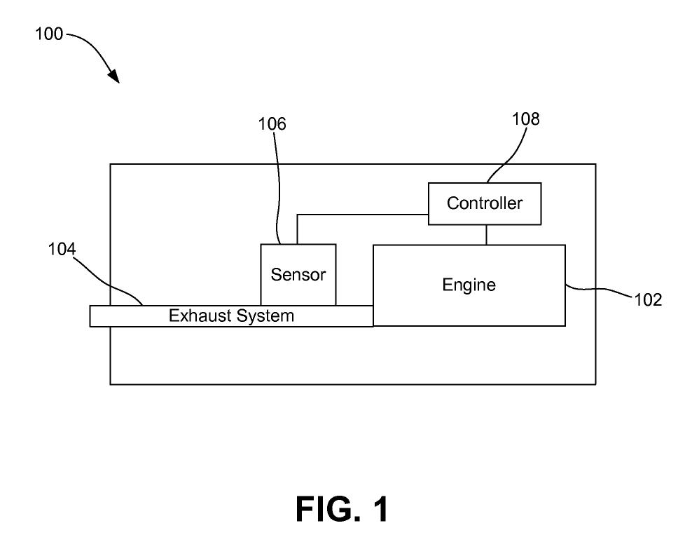

Referring to FIG. 1 an embodiment of a vehicle 100 is schematically depicted. The vehicle 100 may include an internal combustion engine 102 having an exhaust system 104 which may carry a flow of exhaust gasses from the engine 102. A temperature sensor 106 may be coupled to the exhaust system 104 for measuring a temperature of the exhaust gasses carried by the exhaust system 104. The temperature sensor 106 may provide an output responsive to, or indicative of, a temperature of the exhaust gasses. A vehicle control system 108, such as an engine control module (ECM), etc., may receive the output from the temperature sensor 106. The engine control system 108 may vary one or more operating parameters, such as fuel delivery, air/fuel ratio, boost pressure, timing or the like in response to the output of the temperature sensor 106.

Some current temperature sensor designs attempt to address the harsh conditions of the operating environment in which the temperature sensor is exposed. For example, some temperature sensors include potting compounds and/or powdered materials within the sensor tip to provide high temperature conductivity. Some temperature sensors include mineral insulated (MI) cables for the sensor body. Furthermore, some temperature sensors have sensor tips with reduced diameters and/or open-tip designs to provide improved time response. Furthermore, some temperature sensors include coiled or s-bend strain relief components to provide thermal shock relief and prevention of damage due to thermal shock.

Although some current temperature sensor designs attempt to address the relatively harsh conditions of the operating environment, current designs fall short in many areas. For example, many current designs do not adequately withstand extreme thermal shock requirements due to expansion and contraction or material limitations. Furthermore, materials or designs utilized fail to sufficiently provide fast thermal response. Additionally, current mounting features do not sufficiently restrain movement of internal components of temperature sensors during extreme vibration conditions experienced in diesel engine applications, for example.

One aspect of the present disclosure is directed to a temperature sensor configured to reduce movement and breakage of internal components as a result of extreme thermal shock, reduce and prevent fatigue of internal components as a result of extreme vibration conditions, improve thermal response of a closed tip exhaust gas temperature sensor, eliminates the use of mineral insulated cable as a required component, and/or further simplify the manufacturing and assembly processes, thereby reducing the overall cost.

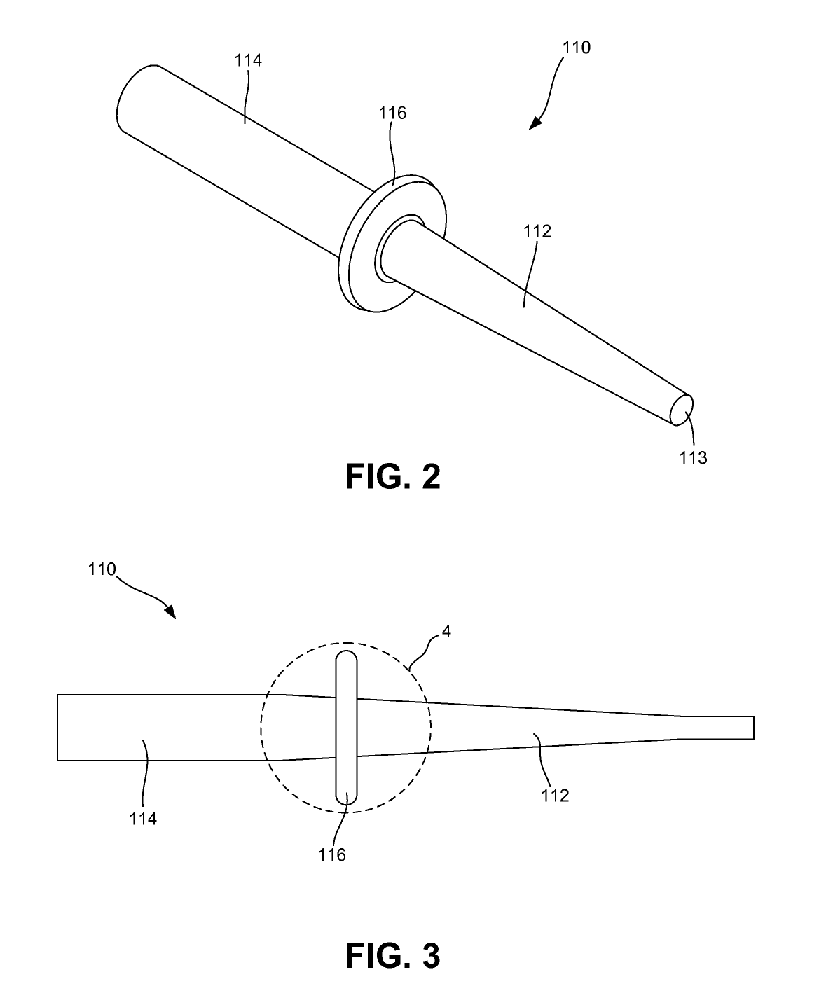

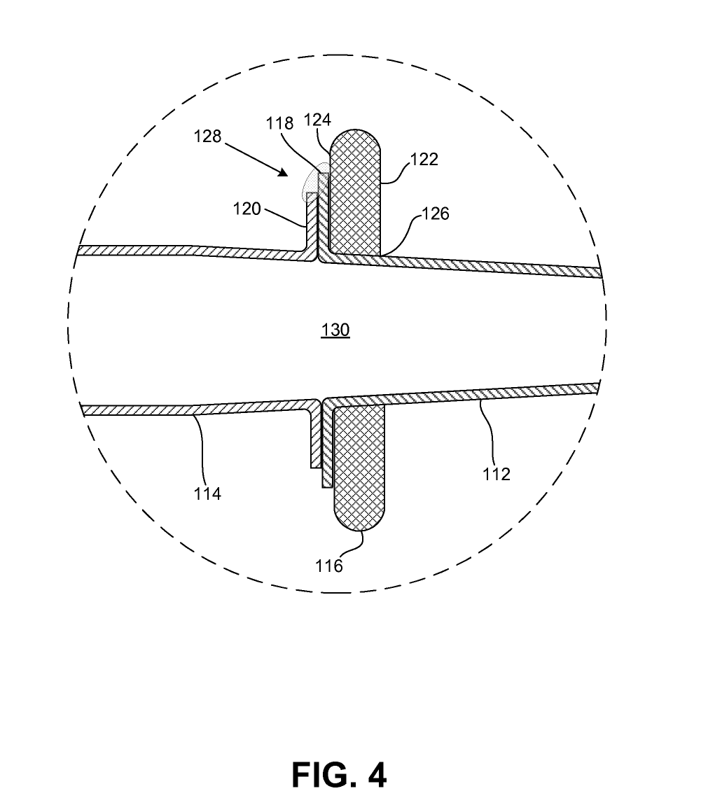

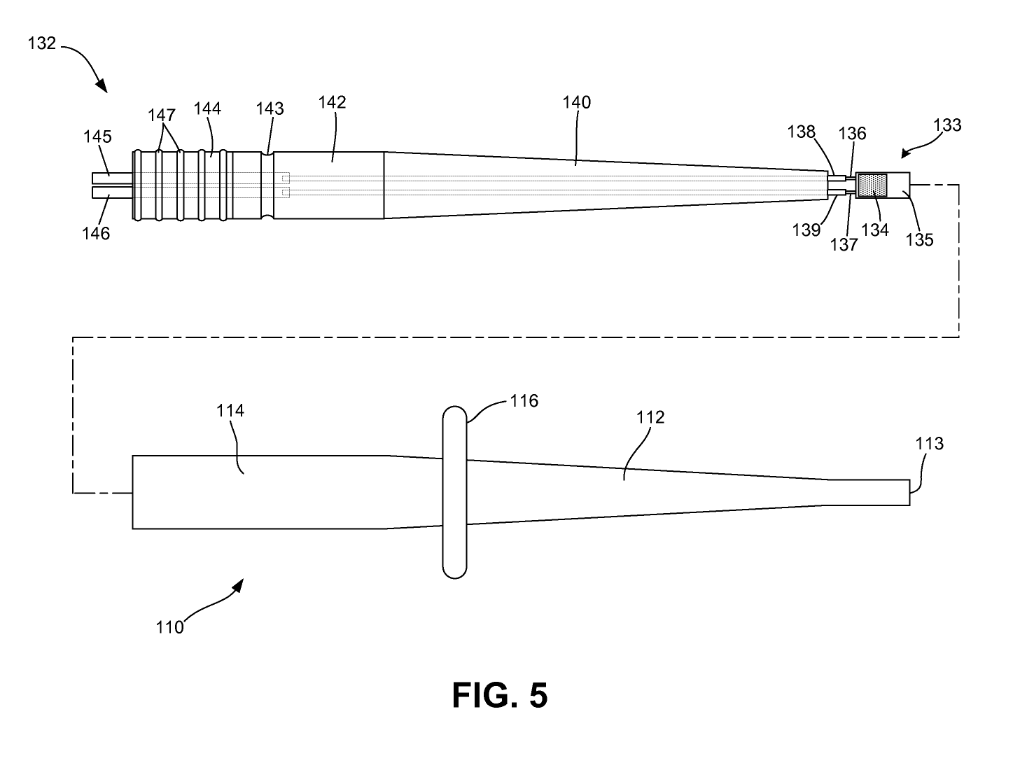

Turning to FIGS. 2 and 3, a housing 110 for use with a temperature sensor consistent with the present disclosure is shown in perspective and side views, respectively. FIG. 4 is an enlarged portion of the housing 110. As shown, the housing 110 is generally a unitary structure that may be formed from two or more components securely fixed to one another. In the illustrated embodiment, the housing 110 generally includes a tip 112, a wire harness sleeve 114 and a mounting flange 116 coupled to one another. The tip 112 and wire harness sleeve 114 are generally tubular in shape and hollow within. As shown, the tip 112 generally tapers and decreases in diameter from an open end 118 (see, for example, FIG. 4) to an opposing closed end 113 (e.g, has a generally frusto-conical shape). As described in greater detail herein, the tapered tip 112 may provide high strength in severe vibration conditions, providing optimum vibration performance. The mass of material at the closed end 113 of the tip 112 may be minimized and stiffness of the open end 118 may be maximized, thereby producing a high natural frequency with little displacement at the closed end 113 of the tip 112 where a sensor element of a temperature sensor assembly (shown in FIG. 5) is mounted. As shown, the open end 118 of the tip 112 includes a flange portion defined along a periphery thereof.

The wire harness sleeve 114 (see, for example, FIG. 4) includes open ends, wherein one open end 120 includes a flange portion defined along a periphery of the open end 120. The mounting flange 116 includes an opening 126 through which the tip 112 may pass through, such that the mounting flange 116 may slide over the exterior of at least the tip 112. The mounting flange 116 includes a first surface 122 and a second surface 124. As generally understood, the mounting flange 116 may be used to mount the housing 110 to a portion of the exhaust gas system (such as, but not limited to, the exhaust manifold, down pipe, or the like) to expose a temperature sensor assembly positioned within the housing 110 to exhaust gases.

When assembled over the tip 112, the second surface 124 of the mounting flange 116 engages a portion of the flange of the open end 118 of the tip 112. The flange portions of the open ends 118, 120 of the tip 112 and wire harness sleeve 114 engage and are fixed to one another and at least the second surface 124 of the mounting flange by way of a single weld, as indicated by arrow 128. When fixed to one another, an interior cavity 130 is formed within the tip 112 and wire harness sleeve 114. A single unitary housing 110 allows a minimum number of fastening points or joints, such as welds, which ultimately simplifies production and minimizes cost. The housing 110 may include a material configured to withstand relatively high temperatures. For example, the housing 110 may be made from high-temperature stainless steel.

FIG. 5 is an exploded view of a temperature sensor 106 including a temperature sensor assembly 132 configured to be positioned within the housing 110 of FIG. 2. The temperature sensor assembly 132 generally includes a temperature sensing element 133. The temperature sensing element 133 may be a resistive temperature sensing element, in which the electrical resistance through the element may vary as a function of temperature. In a particular embodiment, the temperature sensing element 133 may be a thin film resistive temperature detector including at least one metal film 134, e.g. a platinum film, film disposed on a substrate 135. In other embodiments, various temperature sensing elements may be included, such as, for example, resistance temperature detector (RTD), negative temperature coefficient (NTC), positive temperature coefficient (PTC), and/or thermocouple type elements.

The temperature sensing element 133 may include element leads 136, 137 extending therefrom. Electrical conductors 138, 139 for the temperature sensor assembly 132 may be coupled to the respective element leads 136, 137 and may further extend from the temperature sensing element 133 and through remaining components of the temperature sensor assembly 132. As described in greater detail herein, the conductors 138, 139 may be tubular and configured to receive portions of the leads 136, 137, respectively. The tubular conductors 138, 139 may be configured to retain the element leads 136, 137 in position during a welding process, thereby improving means of assembling the temperature sensor 106. Use of tubular conductors 138, 139 may also allow the element leads 136, 137 to be relatively short in length, which may increase resonant frequency of vibrating components, thereby minimizing the opportunity for displacement of the leads 136, 137 and/or fatigue damage as a result of shock and/or vibration.

It should be noted that in other embodiments, the temperature sensor assembly 132 may include additional connections to compensate for any additional features and/or materials. For example, the temperature sensor assembly 132 may include electrical connectors or contacts electrically coupled to the electrical connections for the temperature sensor. Suitable connectors may include integral features as well as pigtail connectors, etc.

In the illustrated embodiment, the temperature sensor assembly 132 further includes a ceramic insulator member 140 having a tapered body, generally corresponding in shape to a portion of the tip 112 of the housing. The ceramic insulator member 140 may include one or more openings defined along the length of the body and configured to receive the conductors 138, 139 within. The ceramic insulator member 140 may be configured to electrically isolate the conductors 138, 139 and further provide support for the conductors 138, 139 and/or temperature sensing element 133 during vibration.

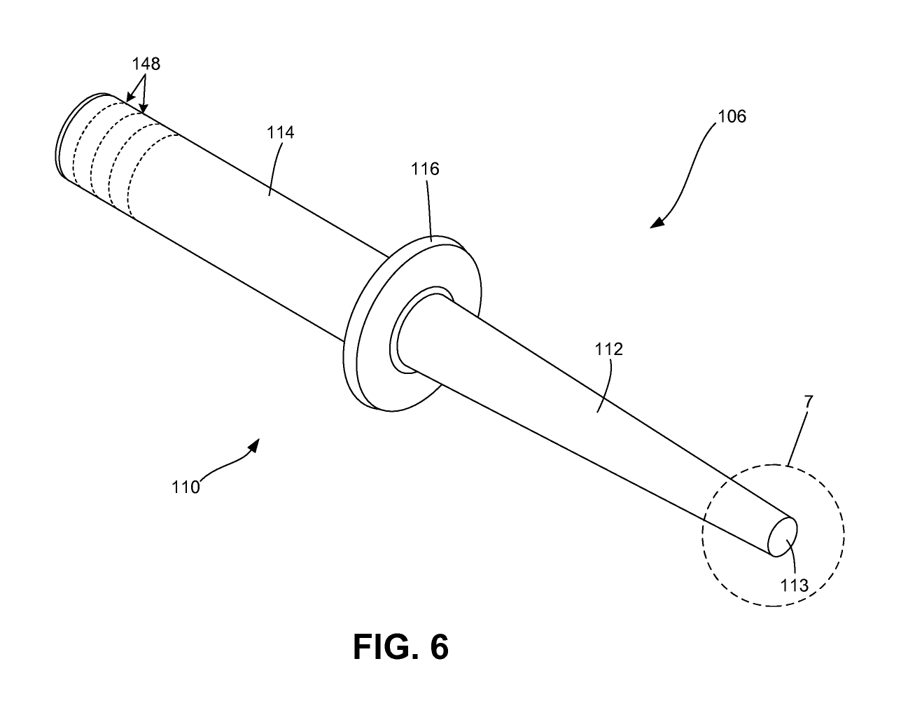

The temperature sensor assembly 132 further includes a strain relief member or nugget 142 positioned adjacent to the ceramic insulator member 140 and a wire seal member or grommet 144 positioned adjacent to the strain relief member 142. The strain relief member 142 may include one or more openings defined along a length thereof and configured to receive and allow the conductors 138, 139 to pass therethrough. The strain relief member 142 may further be configured to receive a pair of wire harness assembly wires 145, 146 coupled to the conductors 138, 139, respectively. The strain relief member 142 may be configured to provide strain relief for the conductors 138, 139 and wire harness assembly wires 145, 146, specifically for welds coupling to the conductors 138, 139 and wires 145, 146 by interlocking with weld terminals between the conductors 138, 139 and wires 145, 146. The strain relief member 142 may further include a groove 143 circumferentially defined along an outer surface thereof. As shown in FIG. 6, for example, the strain relief member 142 may be retained within the interior cavity of the housing 110 by a crimp formed in the housing and protruding into the groove 143 of the strain relief member 142.

The wire seal member 144 may have a hollow tubular cross-section, such that the wire harness assembly wires 145, 146 may pass through the wire seal member 144 and into the interior cavity 130 of the housing. The wire seal member 144 may include a flexible and resilient material, such as a molded high temperature rubber, and may be positioned within the interior cavity 130 of the housing to provide a generally tight seal, thereby preventing moisture and/or other contaminants from entering the housing 110. For example, the wire seal member 144 may include a set of protrusions 147 circumferentially disposed thereon, resembling rings. The protrusions 147 may provide a press-tight fit within the interior cavity 130 of the housing.

As shown in FIG. 6, an assembled temperature sensor 106 is generally illustrated. The temperature sensing element 133 may generally be positioned within the tip 112 and adjacent to the closed end 113. The ceramic insulator member 140 may also be positioned within the tip 112. As previously described, the tapered shaped of the ceramic insulator member 140 may correspond with the tapered shaped of the tip 112, such that the interior cavity 130 of the tip 112 is shaped and/or sized to receive and matingly engage the ceramic insulator member 140.

The strain relief member 142 and wire seal member 144 may be positioned within the wire harness sleeve 114. As shown, a series of crimps 148 are formed in at least the wire harness sleeve 114 of the housing 110, wherein the crimps 148 may protrude inwardly towards the interior cavity and engage portions of the strain relief and wire seal members 142, 144. For example, as previously described, a crimp 148 may protrude into the groove 143 of the strain relief member 142. Furthermore, one or more crimps 148 may protrude in between adjacent protrusions or rings 147 formed on the wire seal member 144. The crimps 148 may further provide a means of retaining the strain relief and/or wire seal members 142, 144 within the housing 110.

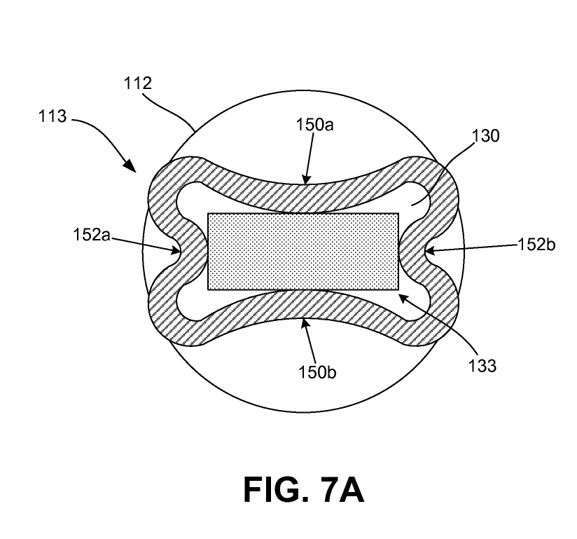

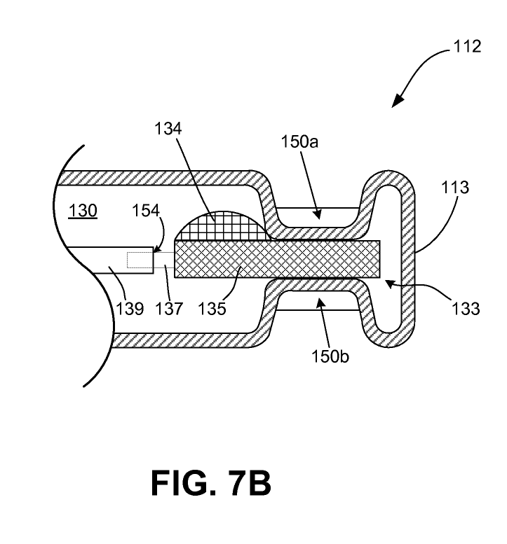

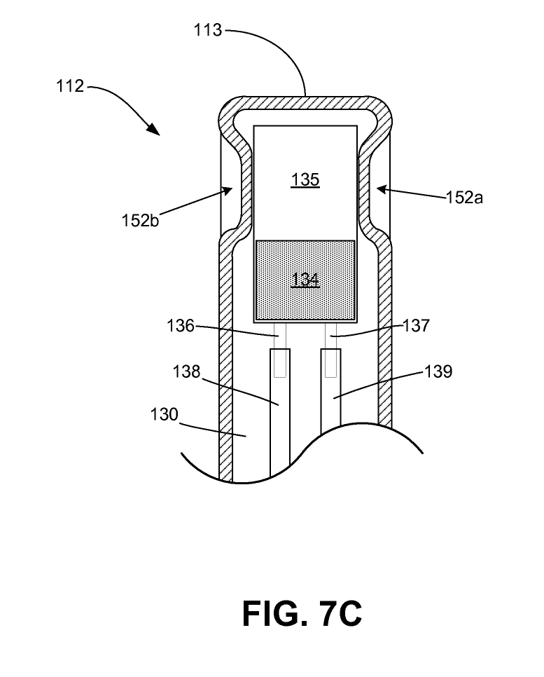

Turning to FIGS. 7A-7C, different sectional views of the closed end 113 of the tip 112 having the temperature sensing element 133 mounted within are shown. As generally described in greater detail herein, the closed end 113 of the tip 112 may be shaped so as to improve performance of the temperature sensor 106. For example, as shown in FIGS. 7A-7C, the closed end 113 is subjected to a heating process and then crimped so as to form a zero clearance fit between the temperature sensing element 133 and the interior surface of the closed end 113 of the tip 112.

FIG. 7A is a front cross-sectional view of the closed end 113 of the tip 112 including the temperature sensing element 133 within and FIGS. 7B and 7C are side and top cross-sectional views of the closed end 113 of the tip 112. In the illustrated embodiment, the closed end 113 includes a first set of crimps 150a, 150b formed on top and bottom portions of the temperature sensing element 133 and a second set of crimps 152a, 152b formed on side portions of the temperature sensing element 133. The crimps are formed so as to protrude inwardly towards the interior cavity 130 and as close to the temperature sensing element 133 as tolerable so as to form a zero clearance fit between the interior surface of the closed end 113 and the sensing element 133. As generally understood, a closed end consistent with the present disclosure may include any number of crimps in a variety of shapes and/or sizes, and need not be limited to those shown in FIGS. 7A-7C.

Generally, prior to formation of the crimps, the closed end 113 of the tip 112 may be generally cylindrical or rectangular (or any other shape) and may be shaped and/or sized to allow the sensing element 133 to easily slip inside during assembly. Heat may then be applied to soften the tip 112 and force may be applied to deform the closed end 113 of the tip 112 onto one or more surfaces (e.g. top, bottom, sides, front, back, etc.) of the sensing element 133, such that crimps may be formed that generally conform to the shape of the surface upon which they were forced upon. Heat may then be removed, and, while the force is maintained, the tip 112 may cool and the closed end 113 may shrink onto the surfaces of the sensing element 133, thereby forming a zero clearance fit between the interior of the closed end 113 and the sensing element 133. During the formation process, the force applied is sufficient to deform the closed end 113 into the desired shape while also avoiding chipping portions of the sensing element 133.

The formation of crimps over the temperature sensing element 133 to form a generally zero clearance fit generally provides retention of the sensing element 133 within the closed end 133 and further restrains relative motion to the element leads 136, 137 during vibration, thereby preventing fatigue fractures. The close fit between the closed end 113 of the tip 112 and sensing element 133 generally provides improved thermal response to temperature changes. Furthermore, thermal expansion of the tip 112 and the closed end 113 at high temperatures may release grip between the closed end 113 and the sensing element 133 and allow the interior surface (e.g. crimps) and the sensing element 133 to slip relative to one another, thereby relieving tension that could potentially wear down and break the element leads 136, 137. As such, the crimping generally eliminates the need for potting or powder materials within the tip and surrounding the sensing element 133.

A temperature sensor consistent with the present disclosure is devoid of any potting or powder materials, as well as an MI cable, while providing improved performance under relatively harsh conditions. For example, the temperature sensor 106, including the housing 110 and temperature sensor assembly 132 described herein, is configured to reduce movement and breakage of the temperature sensing element 133 as a result of extreme thermal shock, reduce and prevent fatigue of the temperature sensing element 133 as a result of extreme vibration conditions, improve thermal response, eliminate the use of mineral insulated cable as a required component, and further simplify the manufacturing and assembly processes, thereby reducing the overall cost.

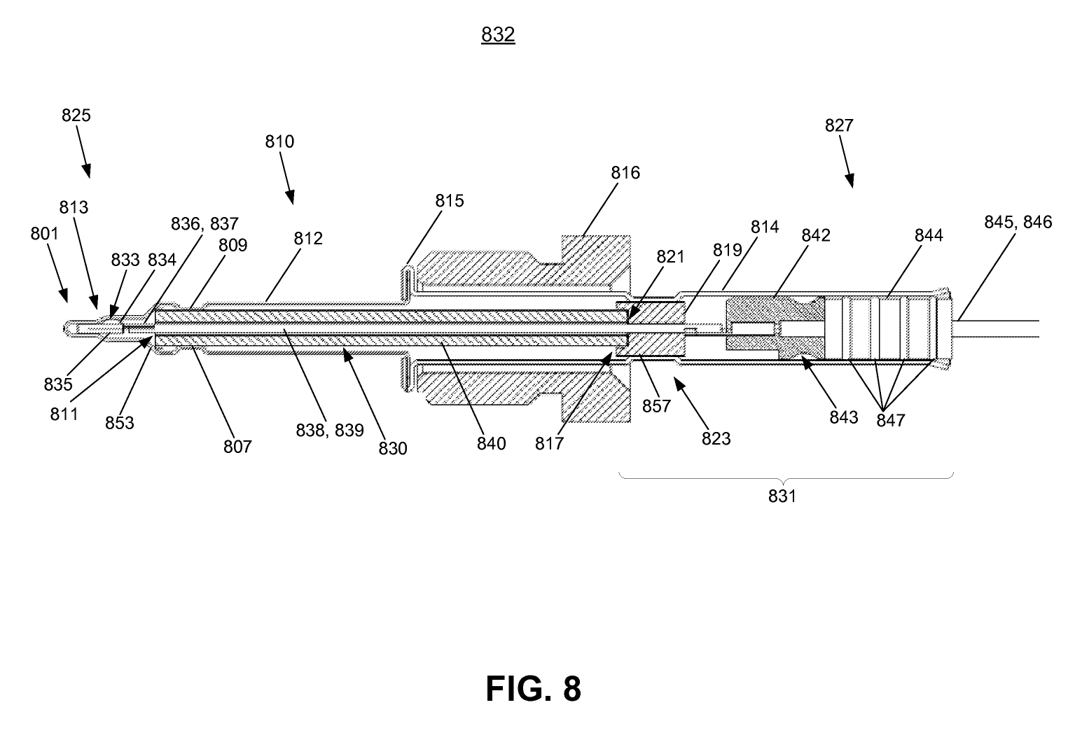

Turning now to FIG. 8, a cross-sectional view of another embodiment of a temperature sensor assembly 832 is generally illustrated. The temperature sensor assembly 832 includes a temperature sensor housing 810, a temperature sensing element 833, an insulator 840, and one or more components 831 configured to locate, seal, and/or provide strain relief. The temperature sensor housing 810 includes a tip body 812, a wire harness body 814, and a stop flange 815. A mounting flange/nut 816 may be provided to secure (e.g., but not limited to, via a threaded connection) the temperature sensor assembly 832 to a portion of the exhaust gas system (such as, but not limited to, the exhaust manifold, down pipe, or the like) and expose the temperature sensor assembly 832 to exhaust gases within the exhaust gas system.

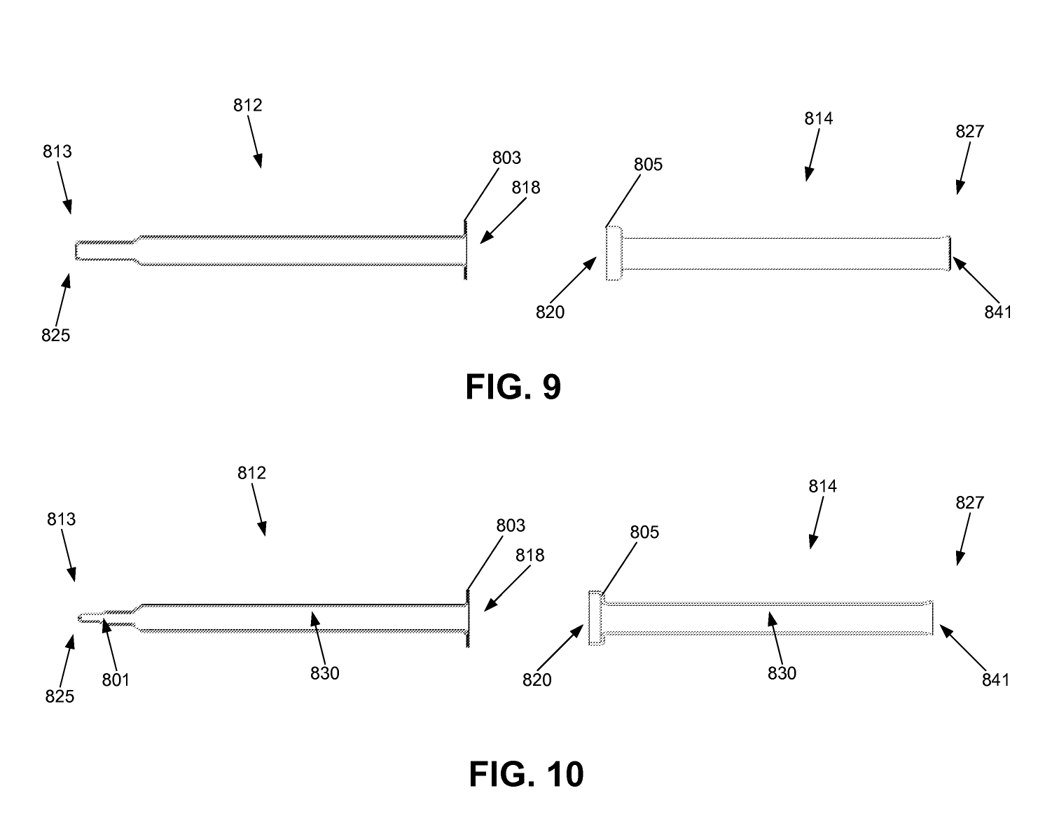

With additional reference to FIGS. 9 and 10, an exploded view and an exploded, cross-sectional view of the tip body 812 and the wire harness body 814 are generally illustrated. The tip body 812 and the wire harness body 814 are generally tubular in shape and hollow within and may be made from high-temperature stainless steel. As shown, the tip body 812 has a generally constant diameter extending from an open end 818 to an opposing closed end 813 which defines a least a portion of an interior cavity 830 including a temperature sensing element cavity 801 (e.g., as generally illustrated in FIGS. 8 and 10). As shown in FIGS. 9 and 10, the open end 818 of the tip body 812 includes a flange portion 803 defined along a periphery thereof which may be coupled to a corresponding flange portion 805 of the wire harness body 814 to form the stop flange 815 as generally illustrated in FIG. 8.

The temperature sensing element cavity 801 is configured to receive at least a portion of the temperature sensing element 833 (e.g., as generally illustrated in FIG. 8). The closed end 813 of the temperature sensing element cavity 801/tip body 812 may be shrunk (e.g., either heat-shrunk and/or cold-shrunk) around at least a portion of a temperature sensing element 833 to form a zero clearance fit between the inside of the temperature sensing element cavity 801 proximate the closed end 813. The temperature sensing element 833 may be located within the temperature sensing element cavity 801 without the use of powder or potting, thereby reducing the mass of material at the closed end 813 and enhancing sensitivity and/or accuracy of the temperature sensing element 833 as generally described herein. For example, heat may be applied to soften the closed end 813 of the temperature sensing element cavity 801/tip body 812. Force is then applied to deform the closed end 813 of the temperature sensing element cavity 801/tip body 812 onto one or more of the surfaces of the temperature sensing element 833. Heat may be removed while maintaining force, allowing the closed end 813 of the temperature sensing element cavity 801/tip body 812 to cool and shrink onto/around at least a portion of the temperature sensing element 833, thereby producing a zero clearance fit between the temperature sensing element 833 and the closed end 813 of the temperature sensing element cavity 801/tip body 812. The temperature sensing element 833 may therefore be in direct or substantially direct contact with the closed end 813 of the temperature sensing element cavity 801/tip body 812, thereby increasing response time and/or accuracy of the temperature sensor assembly 832.

With reference to FIGS. 9-10, the wire harness sleeve body 814 includes open ends 820, 841, wherein a first open end 820 includes the flange portion 805 defined along a periphery of the open end 820. The flange portions 803, 805 of the tip body 812 and the wire harness sleeve body 814 may be coupled together to form at least a portion of the interior cavity 830 (e.g., as generally illustrated in FIGS. 8 and 10) and the stop flange 815 (e.g., as generally illustrated in FIG. 8). According to one embodiment, one or more of the flange portions 803, 805 is crimped over at least a portion of the other flange portion 803, 805 to couple and secure the tip body 812 and the wire harness sleeve body 814 together to form the stop flange 815 and a unitary structure. The flange portions 803, 805 may be crimped together either with or without the use of welding, adhesives, or the like.

Referring back to FIG. 8, the temperature sensor assembly 832 includes a temperature sensing element 833. The temperature sensing element 833 may be a resistive temperature sensing element, in which the electrical resistance through the element may vary as a function of temperature. In a particular embodiment, the temperature sensing element 833 may be a thin film resistive temperature detector including at least one metal film 834, e.g. a platinum film, film disposed on a substrate 835. In other embodiments, various temperature sensing elements may be included, such as, for example, resistance temperature detector (RTD), negative temperature coefficient (NTC), positive temperature coefficient (PTC), and/or thermocouple type elements.

The temperature sensing element 833 may include element leads 836, 837 (only one of which is visible in the illustrated cross-section) extending therefrom. Optionally, electrical conductors 838, 839 (again, only one of which is visible in the illustrated cross-section) for the temperature sensor assembly 832 may be coupled to the respective element leads 836, 837 and may further extend from the temperature sensing element 833 and through remaining components of the temperature sensor assembly 832. As described in greater detail herein, the conductors 838, 839 may be tubular and configured to receive portions of the leads 836, 837, respectively. The conductors 838, 839 may be configured to retain the element leads 836, 837 in position during a welding process, thereby improving means of assembling the temperature sensor assembly 832. Use of conductors 838, 839 may also allow the element leads 836, 837 to be relatively short in length, which may increase resonant frequency of vibrating components, thereby minimizing the opportunity for displacement of the leads 836, 837 and/or fatigue damage as a result of shock and/or vibration.

It should be noted that in other embodiments, the temperature sensor assembly 832 may include additional connections to compensate for any additional features and/or materials. For example, the temperature sensor assembly 832 may include electrical connectors or contacts electrically coupled to the electrical connections for the temperature sensor. Suitable connectors may include integral features as well as pigtail connectors, etc.

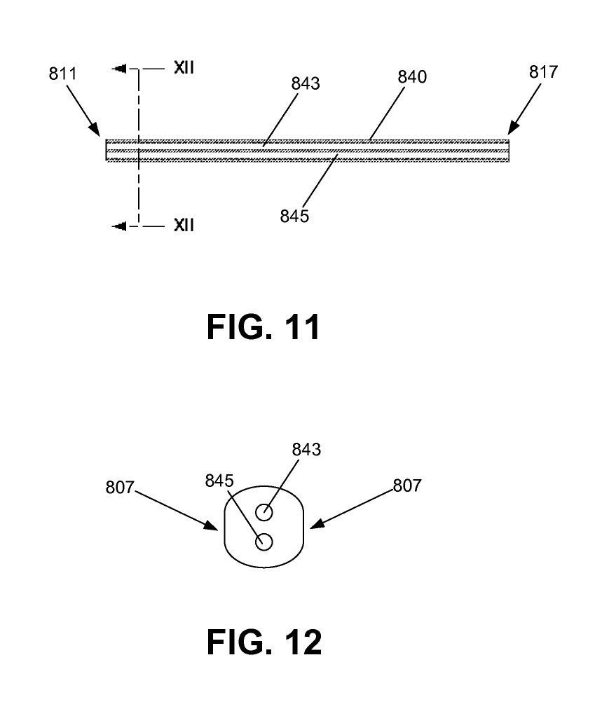

In the illustrated embodiment, the temperature sensor assembly 832 further includes a ceramic insulator member 840. Cross-sectional views of the insulator member 840 are generally illustrated in FIGS. 11 and 12, which should be viewed in combination with FIG. 8. The insulator member 840 may have a body that generally corresponds to the shape of at least a portion of the interior cavity 830. The ceramic insulator member 840 may include one or more openings 843, 845 defined along the length of the body and configured to receive the conductors 838, 839 within. The ceramic insulator member 840 may be configured to electrically isolate the conductors 838, 839 and further provide support for the conductors 838, 839 and/or temperature sensing element 833 during vibration.

The insulator member 840 is advanced into the interior cavity 830. The insulator member 840 may be retained in the interior cavity 830 with a heat shrinking process similar to the process used to retain the temperature sensing element 833 in the temperature sensing element cavity 801. According to one embodiment, zero clearance is maintained between the insulator member 840 and the interior cavity 830 to improve vibration resistance of the temperature sensor assembly 832. A first or distal end 811 of the insulator member 840 may be centered in the interior cavity 830 by advancing the insulator member 840 into the interior cavity 830 until at least a portion of the distal end 811 of the insulator member 840 contacts a seat or shoulder region 853 of the interior cavity 830 as generally illustrated in FIG. 8. According to the illustrated embodiment, the insulator member 840 contacts a conical seat 853 formed in the tip body 812, though the seat or shoulder region 853 may alternatively be formed in the wire harness body 814 and/or may be formed at the coupling junction of the tip body 812 and the wire harness body 814 (e.g., in the area proximate to the stop flange 815).

The second or proximal end 817 may be centered within the interior cavity 830 by a spacer 819. For example, the spacer 819 (which may be formed from ceramic) may include one or more openings defined along a length thereof and configured to receive and allow the conductors 838, 839 to pass therethrough. The spacer 819 may also include a recessed region 821 configured to receive and center the proximal end 817 of the insulator member 840. According to one embodiment, a portion of the temperature sensor housing 810 (e.g., but not limited to, the wire harness body 814), which initially has a generally circular cross-section in the areas proximate to the spacer 819, is crimped inwardly to form one or more spacer crimps 823 which contact the spacer 819 to secure the spacer 819 within the interior cavity 830. For example, the spacer 819 may include one or more non-circular regions 857 configured to engage (e.g., abut against) the spacer crimp 823 to secure the spacer 819 within the interior cavity 830 (e.g., to prevent longitudinal movement of the spacer 819 relative to the interior cavity 830). The non-circular region 857 may include, but are not limited to, planar or flat regions, protrusions, indentations, grooves, lips, shoulders, or the like. It may be appreciated that the spacer 819 may also reduce the amount of heat transferred from the distal end 825 of the temperature sensor assembly 832 to the proximal end 827 of the temperature sensor assembly 832. Alternatively, the spacer 819 may have an outer periphery or diameter which substantially corresponds to the inner periphery or diameter of the interior cavity 830 and the spacer 819 may be held in place by the strain relief/nugget 842 and/or wire seal/grommet 844.

The insulator member 840 optionally includes one or more non-circular regions 807 (e.g., as generally illustrated in FIGS. 8 and 12). The non-circular regions 807 may include, but are not limited to, planar or flat regions, protrusions, indentations, grooves, lips, shoulders, or the like. The non-circular regions 807 are configured to engage a portion of the temperature sensor housing 810 (e.g., but not limited to, the tip body 812) to reduce and/or prevent the insulator member 840 from rotating relative to the temperature sensor housing 810 due to vibration. In the exemplary embodiment, the insulator member 840 includes two planar/flat non-circular regions 807 which are molded into the insulator member 840 generally opposite each other. The temperature sensor housing 810 may be secured to the non-circular region 807, for example, using one or more insulator crimps 809. In the illustrated embodiment, the tip body 812 (which initially has a generally circular cross-section in the areas proximate to the two non-circular regions 807) may be crimped inwardly to form two insulator crimps 809 which contact the two non-circular regions 807 of the insulator member 840.

The location of one or more of the non-circular regions 807 and/or the insulator crimps 809 may be selected/adjusted along the length of the insulator member 840 and/or the tip body 812 to change the resonant frequency of the temperature sensor assembly 832 for a specific application. The ability to select/adjust the resonant frequency of the temperature sensor assembly 832 allows that the temperature sensor assembly 832 to withstand the severe vibrations encountered in many applications (for example, but not limited to, automotive applications). For example, the location of the non-circular regions 807 and/or the insulator crimps 809 may allow for the resonant frequency of the insulator member 840 to be selected such that the resonant frequency is outside of the operating range of the temperature sensor assembly 832 for a particular application, thereby minimizing potential damage to the insulator member 840 and/or any other part of the temperature sensor assembly 832 (such as, but not limited to, the temperature sensing element 833, the element leads 836, 837, and/or the conductors 838, 839).

As mentioned above, the temperature sensor assembly 832 may further include a strain relief member or nugget 842 as generally illustrated in FIG. 8. According to one embodiment, the nugget 842 may be positioned adjacent to the spacer 819. The strain relief member 842 may include one or more openings defined along a length thereof and configured to receive and allow the conductors 838, 839 to pass therethrough. The strain relief member 842 may be further configured to receive a pair of wire harness assembly wires 845, 846 (only one of which is visible in the cross-sectional view of FIG. 8) coupled to the conductors 838, 839, respectively. The strain relief member 842 may be configured to provide strain relief for the conductors 838, 839 and wire harness assembly wires 845, 846, specifically for welds coupling to the conductors 838, 839 and wires 845, 846 by interlocking with weld terminals between the conductors 838, 839 and wires 845, 846. The strain relief member 842 may further include a groove 843 circumferentially defined along an outer surface thereof. While not shown, the strain relief member 842 may be retained within the interior cavity 830 by a crimp formed in the temperature sensor housing 810 (e.g., but not limited to, the wire harness body 814) which protrudes into and engages the groove 843 of the strain relief member 842. According to an alternative embodiment, the spacer and the nugget 842 may be combined into a single component, and the resulting component may be adjacent to the ceramic insulator member 840.

A wire seal member or grommet 844 may be positioned adjacent to the strain relief member 842. The wire seal member 844 may have a hollow tubular cross-section, such that the wire harness assembly wires 845, 846 may pass through the wire seal member 844 and into the interior cavity 830 of the temperature sensor housing 810. The wire seal member 844 may include a flexible and resilient material, such as a molded high temperature rubber, and may be positioned within the interior cavity 830 of the temperature sensor housing 810 to provide a generally tight seal, thereby preventing moisture and/or other contaminants from entering the temperature sensor housing 810. For example, the wire seal member 844 may include a set of protrusions 847 circumferentially disposed thereon, resembling rings. The protrusions 847 may provide a press-tight fit within the interior cavity 830 of the temperature sensor housing 810.

Thus, according to one aspect, the present disclosure features a temperature sensor assembly including a temperature sensing element and a temperature sensor housing. The temperature sensor housing defines an interior cavity, wherein a distal end region of the interior cavity includes a temperature sensing element cavity defined by a closed end of the temperature sensor housing and configured to receive at least a portion of the temperature sensing element. At least a portion of the temperature sensing element cavity is shrunk around at least a portion of the temperature sensing element.

According to another aspect, the present disclosure features a temperature sensor assembly including a tip body, a wire harness body, a crimp coupling, and a temperature sensing element. The tip body includes a closed end and an open end, the open end having a first flange portion. The wire harness body includes two open ends, wherein one of the open ends includes a second flange portion. The crimp couples the first and the second flange portions together to form a temperature sensor housing. The temperature sensor housing defines an interior cavity. The temperature sensing element is disposed within at least a portion of the interior cavity.

In yet another aspect, the present disclosure features a temperature sensor housing, a temperature sensing element disposed proximate to a first end of the temperature sensor housing, an insulating member disposed within the temperature sensor housing, and at least one insulator crimp configured to extend generally inwardly toward at least a portion of the insulating member to prevent the insulating member from rotating relative to the temperature sensor housing. The location of the at least one insulator crimp along the temperature sensor housing is selected based on a resonant frequency of the temperature sensor assembly.

In a further aspect, the present disclosure features a method of forming a temperature sensor assembly. The method includes advancing a temperature sensing element within a temperature sensing element cavity defined by a closed end of a temperature sensor housing, and shrinking at least a portion of the temperature sensing element cavity around at least a portion of the temperature sensing element to at least partially secure the temperature sensing element within the temperature sensing element cavity.

Yet another aspect of the present disclosure features a method of forming a temperature sensor assembly, wherein the temperature sensor housing includes a tip body having a closed end and an open end including a first flange portion, and a wire harness body having an open end including a second flange portion. The method includes coupling the first and the second flange portions together to form a temperature sensor housing, wherein temperature sensor housing defines an interior cavity, and advancing a temperature sensing element within at least a portion of the interior cavity.

A further aspect of the present disclosure features a method of forming a temperature sensor assembly including advancing an insulating member within a portion of a temperature sensor housing, and crimping a portion of the temperature sensing housing inwardly toward at least a portion of the insulating member to prevent the insulating member from rotating relative to the temperature sensor housing, wherein the location of the at least one insulator crimp along the temperature sensor housing is selected based on a resonant frequency of the temperature sensor assembly.

According to another aspect, the present disclosure features a temperature sensor assembly including temperature sensing element and a temperature sensor housing defining an interior cavity. A distal end region of the interior cavity includes a temperature sensing element cavity defined by a closed end of the temperature sensor housing and configured to receive at least a portion of the temperature sensing element. At least a portion of the temperature sensing element cavity is shrunk around at least a portion of the temperature sensing element. The temperature sensing element cavity may be heat-shrunk and/or cold-shrunk around at least a portion of the temperature sensing element.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

What is claimed is:

1. A temperature sensor assembly comprising:
a temperature sensing element; and
a temperature sensor housing defining an interior cavity, wherein a distal end region of said interior cavity includes a temperature sensing element cavity defined by a closed end of said temperature sensor housing and configured to receive at least a portion of said temperature sensing element;
wherein at least a portion of said temperature sensing element cavity is shrunk around at least a portion of said temperature sensing element.

2. The temperature sensor assembly of claim 1, wherein at least a portion of said temperature sensing element cavity is heat shrunk around at least a portion of said temperature sensing element.

3. The temperature sensor assembly of claim 1, wherein at least a portion of said temperature sensing element cavity is cold shrunk around at least a portion of said temperature sensing element.

4. The temperature sensor assembly of claim 1, wherein said temperature sensor housing comprises:
a tip body including an open end and said closed end, said open end including a first flange portion;
a wire harness body including two end opens, wherein one of said open ends includes a second flange portion; and
a crimp coupling said first and said second flange portions together to form said temperature sensor housing.

5. The temperature sensor assembly of claim 1, wherein said temperature sensor assembly does not include a powder or potting material disposed within said temperature sensing element cavity.

6. The temperature sensor assembly of claim 1, further comprising an insulating member disposed within said temperature sensor assembly, said insulating member including at least one non-circular region disposed between said first and said second ends, and wherein said temperature sensor housing includes at least one insulator crimp configured to extend generally inwardly toward at least a portion of said non-circular region of said insulating member and prevent said insulating member from rotating relative to said temperature sensor housing.

7. A temperature sensor assembly comprising:
a tip body including a closed end and an open end, said open end including a first flange portion;
a wire harness body including two open ends, wherein one of said open ends includes a second flange portion;
a crimp coupling said first and said second flange portions together to form a temperature sensor housing, wherein temperature sensor housing defines an interior cavity; and
a temperature sensing element disposed within at least a portion of said interior cavity.

8. The temperature sensor assembly of claim 7, further comprising an insulating member disposed within said temperature sensor assembly.

9. The temperature sensor assembly of claim 8, wherein least a portion of said insulating member includes a generally cylindrical shape including a first end, a second end, and at least one longitudinal opening extending therethrough.

10. The temperature sensor assembly of claim 8, wherein said insulating member includes at least one non-circular region disposed between said first and said second ends.

11. The temperature sensor assembly of claim 10, wherein said non-circular region includes a planar region molded into said insulator member.

12. The temperature sensor assembly of claim 10, wherein said temperature sensor housing includes at least one insulator crimp configured to extend generally inwardly toward at least a portion of said non-circular region of said insulating member and prevent said insulating member from rotating relative to said temperature sensor housing.

13. The temperature sensor assembly of claim 9, wherein interior cavity includes at least one generally conical seat configured to contact against and center said first end of said insulating member within said interior cavity.

14. The temperature sensor assembly of claim 8, wherein at least a portion of said tip body generally tapers such that at least a portion of said closed end has a smaller diameter than said open end, and wherein said insulating member has a tapered body which generally corresponds to said taper of said tip body.

15. A temperature sensor assembly comprising:
a temperature sensor housing;
a temperature sensing element disposed proximate to a first end of said temperature sensor housing;
an insulating member disposed within said temperature sensor housing; and
at least one insulator crimp configured to extend generally inwardly toward at least a portion of said insulating member to prevent said insulating member from rotating relative to said temperature sensor housing;
wherein a location of said at least one insulator crimp along said temperature sensor housing is selected based on a resonant frequency of said temperature sensor assembly.

16. The temperature sensor assembly of claim 15, wherein at least a portion of said insulating member includes a generally cylindrical shape including a first end, a second end, and at least one longitudinal opening extending therethrough.

17. The temperature sensor assembly of claim 16, further comprising a conductor configured to be disposed within at least a portion of said longitudinal opening of said insulating member, said conductor having a first end electrically coupled to an element lead of said temperature sensing element and a second end electrically coupled to a wire harness assembly wire.

18. The temperature sensor assembly of claim 15, wherein said insulating member includes at least one non-circular region disposed between said first and said second ends.

19. The temperature sensor assembly of claim 18, wherein said non-circular region includes a planar region molded into said insulator member.

20. The temperature sensor assembly of claim 15, wherein said at least one insulator crimp is configured to contact at least a portion of said non-circular region of said insulating member.
